(19) United States
(12) Patent Application Publication
(10) Pub. No.: US 2023/0056407 A1
(43) Pub. Date: Feb. 23, 2023

(54) PORTABLE FOLDABLE YURT

(71) Applicant: Bayarjargal Tsevegdorj Sereenen, Naperville, IL (US)

(72) Inventor: TSOGOO BAASANJAV, ALAMEDA, CA (US)

(21) Appl. No.: 17/892,041

(22) Filed: Aug. 19, 2022

Related U.S. Application Data
(60) Provisional application No. 63/235,367, filed on Aug. 20, 2021.

(51) Int. Cl. E04H 15/46; E04H 15/54

(52) U.S. Cl. CPC E04H 15/46; E04H 15/54

(57) ABSTRACT

The present invention comprises a novel foldable yurt structure generally consisting of at least two foldable lattice walls and a foldable lattice roof. The foldable roof is to be positioned substantially on top of the foldable walls. Once the roof sits on the wall and securely and fastened with zip ties, an inner tension band or rope is encircled to prevent structure expand and hold the structure in substantially same structural position. The whole structure is covered by PVC tarpaulin, Vinyl tarpaulin, or polyethylene tarpaulin.

### BACKGROUND

The present invention relates to a foldable yurt that could be used for all outdoor activities such as camping, hunting, hiking, and yoga retreats. The invention is based on traditional Mongolian yurt structure. The Mongolian yurt has been used by nomads for thousands of years as a sole mean of dwelling in throughout south east Asia. Although Mongol yurt is easy to put up, take down, and pack up, it takes about at least 2 persons and 2-3 hours to do so. Therefore, the traditional Mongol yurt has not been used for modern day activities, such as camping, hunting, hiking, and yoga retreats. In short, this invention drastically shortens the time amount that is needed to put up, take down, and pack up, so that it makes so much easier to use it for many purposes. For this invention, only one person can load up, put up, take down, and pack up in matter of a few minutes.

### BRIEF SUMMARY OF THE INVENTION

This invention consists of two foldable walls (it can be more than two parts/walls depending on size of Yurt) and a foldable lattice roof which consists of five pieces of lattice structures (it can be more than five depending on size of Yurt). While roofs of traditional yurt consist of many wooden radial rafters (25-45 rafters usually), this invention substitutes the rafters with a simple lattice roof. Furthermore, the unique structural features allow not to use 2 posts to support dome and roof, while traditional Mongolian yurts require 2 posts for support.

### DETAILED DESCRIPTION

New yurt, its parts, and positioning of them are discussed herein. In the following description, for purposes of explanation, specific details are set forth in order to provide a thorough understanding of the present invention. It will be evident, however, to one skilled in the art that the present invention may be practiced without these specific details. The present disclosure is to be considered as an exemplification of the invention, and is not intended to limit the invention to the specific embodiments illustrated by the figures or description below.

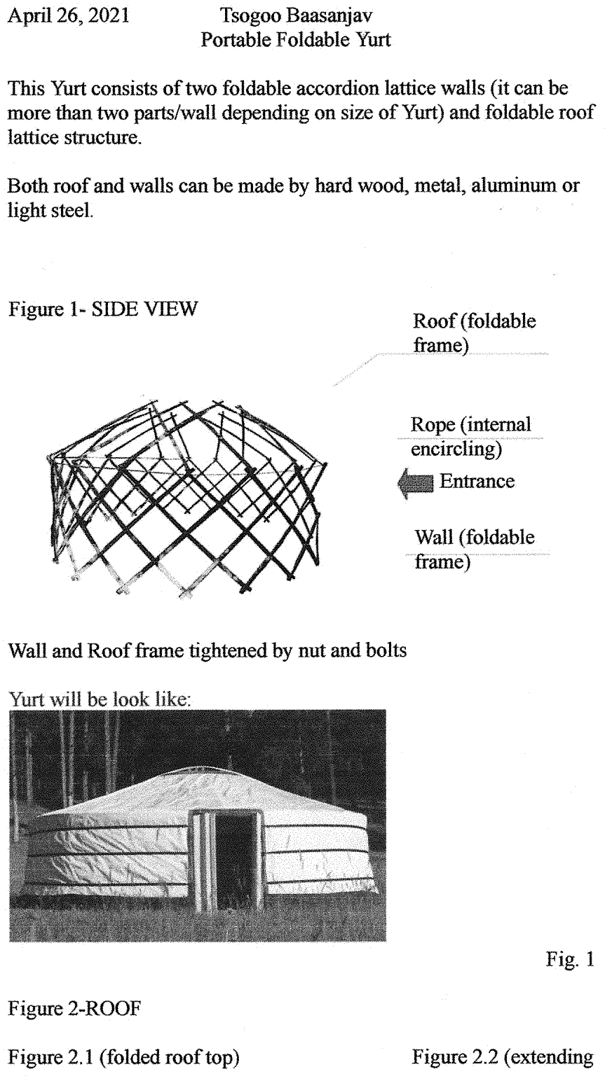

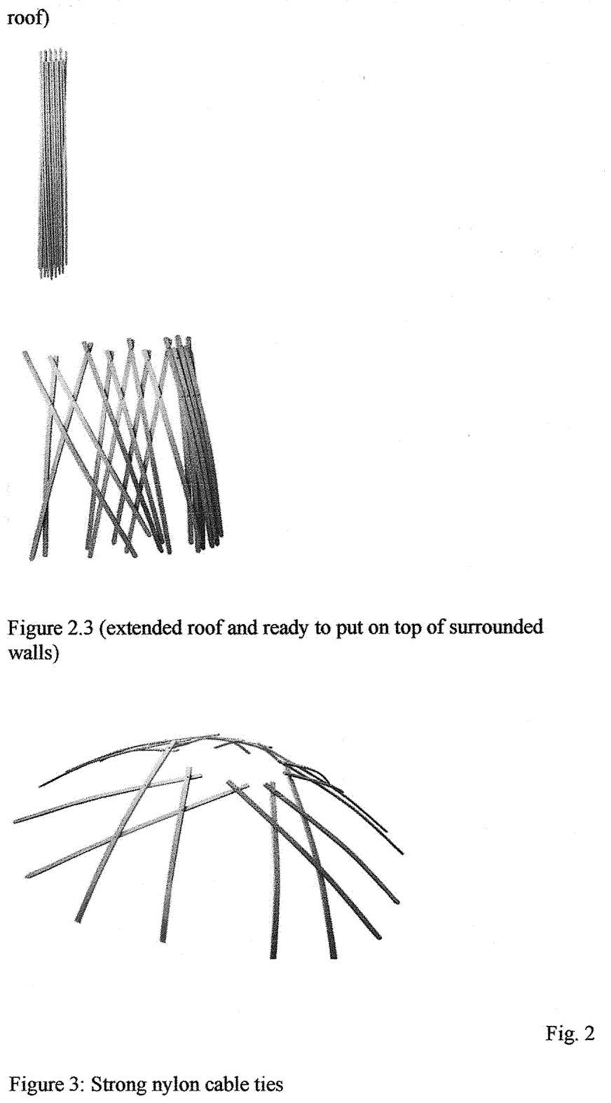

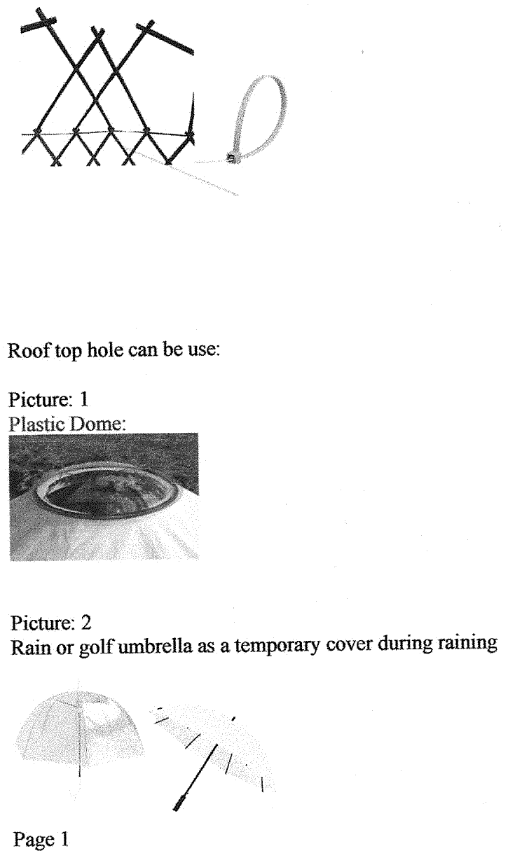

The present invention will now be described by referencing the appended figures representing preferred embodiments. FIG. 1 depicts a side perspective view of the elements that may comprise a foldable yurt according to various embodiments of the present invention. In preferred embodiments, each of the elements of the foldable yurt are configured with at least two foldable walls and a foldable roof. The foldable roof consists of five or more light strips (it can be more than five depending on size of Yurt). All parts can be made by any types wood. Also, they can be made by metal, aluminum or any light steel. All structural strips of Walls and Roof's frame fastened or tightened by nuts and bolts. Bottom of roof sticks connect to wall top by nylon standard cable ties. The whole structure is covered by waterproof materials such as nylon coated with a layer of silicone, PVC tarpaulin, Vinyl tarpaulin, or polyethylene tarpaulin. After the outer cover covers the structure, the lattice walls are encircled around with 2-3 tension bands or ropes and each end of the bands or ropes are fastened to the end of the lattice walls. The inventions could have either whole area or partial floor made out of water proof materials such as nylon coated with a layer of silicone, PVC tarpaulin, Vinyl tarpaulin, or polyethylene tarpaulin. Also, the dome of the invention could have more em bodiments such as one with circular hole for stove exhaust pipe or chimney pipe.

### OPERATION

The said invention will be used by people who do all kinds of outdoor activities as means of shelter in all kinds of weather conditions, especially in colder climate areas. Also, the invention could be used in natural disaster relief operations and refugee camps. The main advantages of the invention over traditional Mongolian yurts are it requires significantly shorter time for setting up and packing up and it provides opportunity to operate a small size portable stove for cooking and staying warm in cold climate areas. Furthermore, the invention has much more capacity to stand against strong wind, rain storm, and snow storm, due to its structural frame uniqueness i.e., lattice roof.

### CONCLUSION

The invention gives an opportunity to people who do all kinds of outdoor activities to have more reliable, sturdy, easy to use, shelter at significantly low cost.

I claim:

1. Portable and foldable yurt comprising lattice roof, lattice wall, door structure, dome, inner tension band, cover, and floor.

2. The lattice roof of claim 1 wherein said body of material is composed of lightweight woods like bamboo, willow, basswood, balsa, pine, cypress, fir, ash, corkwood, spruce, maple, walnut, or oak.

3. The lattice roof of claim 1 wherein said body of material is composed of lightweight metals like aluminum, beryllium, titanium, or magnesium alloys.

4. The lattice roof of claim 1 wherein said body of material is composed of lightweight composite materials like graphite/epoxy, Kevlar/epoxy, or boron/epoxy composites.

5. The lattice wall of claim 1 wherein said body of material is composed of lightweight woods like bamboo, willow, basswood, balsa, pine, cypress, fir, ash, corkwood, spruce, maple, walnut, or oak.

6. The lattice wall of claim 1 wherein said body of material is composed of lightweight metals like aluminum, beryllium, titanium, or magnesium alloys.

7. The lattice wall of claim 1 wherein said body of material is composed of lightweight composite materials like graphite/epoxy, Kevlar/epoxy, or boron/epoxy composites.

8. The cover of claim 1 wherein said body of material composed of waterproof materials, such as nylon with silicon coat, PVC tarpaulin, vinyl tarpaulin, or polyethylene tarpaulin.

9. The floor of claim 1 wherein said body of material composed of waterproof materials, such as nylon with silicon coat, PVC tarpaulin, vinyl tarpaulin, or polyethylene tarpaulin.
